(19) United States
(12) Patent Application Publication
(10) Pub. No.: US 2006/0080659 A1
(43) Pub. Date: Apr. 13, 2006

(54) System and method of provisioning software to mobile devices

(75) Inventor: Kiran K. Ganji, Irving, TX (US)

Correspondence Address: HAYNES AND BOONE, LLP, 901 MAIN STREET, SUITE 3100, DALLAS, TX, 75202, US

(73) Assignee: JP Mobile Operating, L.P., Dallas, TX (US)

(21) Appl. No.: 10/964,797

(22) Filed: Oct. 13, 2004

(51) Int. Cl. G06F 9/445

(52) U.S. Cl. 717/178

(57) ABSTRACT

A system of provisioning software comprises a server operable to communicate wirelessly with a plurality of mobile devices, a data storage accessible by the server and operable to store device characteristics and device type of the plurality of mobile devices, and a user interface operable to receive a device registration from each of the plurality of wireless devices. The server is operable to configure and download an installer file that includes at least one software application bundled with at least one configuration parameter to the plurality of mobile devices via wireless communication.

### BACKGROUND

Increasingly, mobile devices are designed with the ability to accept downloaded software to add to their functionality and flexibility. Users may download software to their desktop computers and then with a communication link, such as Universal Serial Bus (USB), proprietary connection protocols, custom cradles, and/or other connections, the software is transferred and installed on the mobile device. Additionally, some software require the user to manually enter application configuration parameters using the desktop computer before they can become operational. This method of provisioning software ties the user to a desktop computer and going through manual steps thereafter, without taking advantage of the wireless communication capability of mobile devices.

Although wireless download of software to mobile devices has been contemplated, the variety in device types, software applications, communication networks, and the endless combinations of the foregoing makes this a daunting challenge.

### BRIEF DESCRIPTION OF THE DRAWINGS

FIG. 1 is a simplified block diagram of an embodiment of a system of provisioning software to mobile devices; and

FIG. 2 is a flowchart of an embodiment of a method of provisioning software to mobile devices.

### DETAILED DESCRIPTION

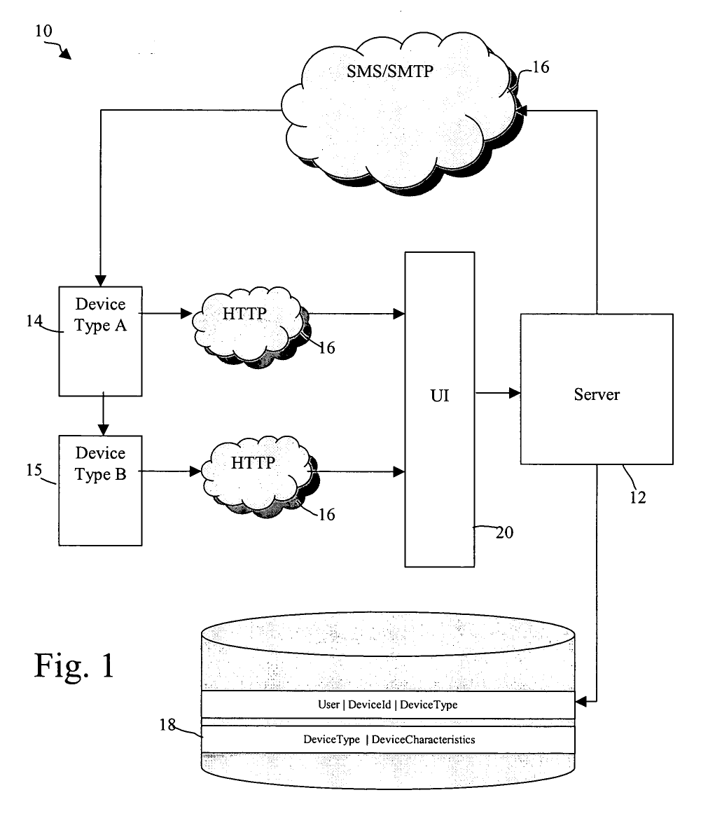

FIG. 1 is a simplified block diagram of an embodiment of a system 10 of provisioning software to mobile devices. System 10 comprises a server 12 that is operable to communicate with a plurality of mobile devices 14 and 15 over a computer network 16 such as the Internet. Mobile devices 14 and 15 may include mobile telephones, personal digital assistants, pocket personal computers, laptop computers, portable music players, portable video players, portable gaming devices, multi-function combination devices, etc. Software application code as well as configuration parameters related to the user, the application and the device may be stored in a data storage device or database 18. A user interface 20 provides an easy-to-use and easy-to-navigate interface for user registration. User interface 20 may be a web or Hypertext Markup Language (HTML) interface, for example. Any hardware and configuration that may satisfy the functional requirements described herein may be used.

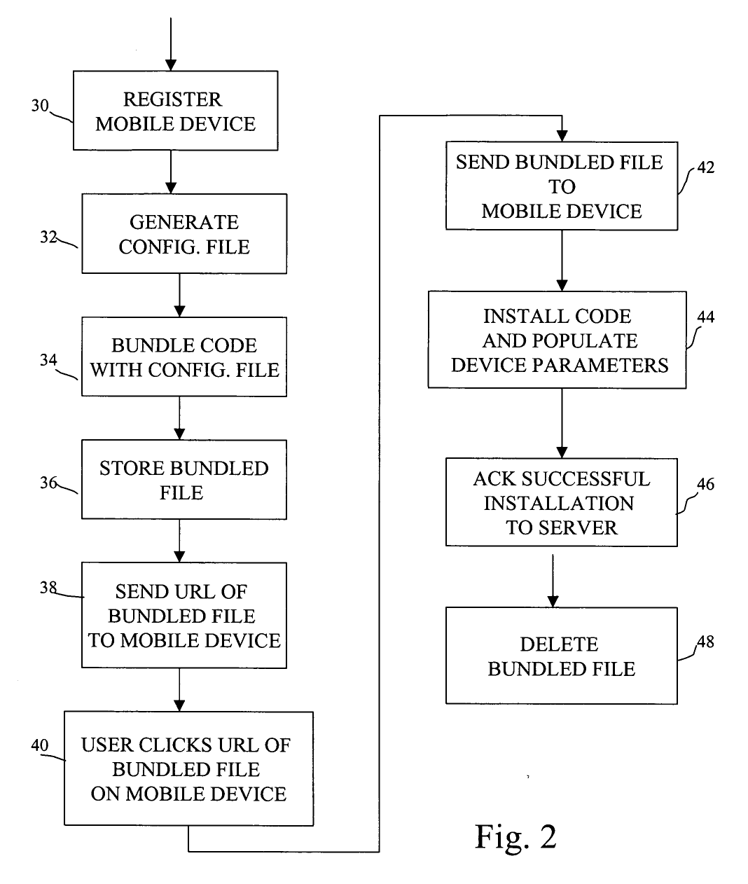

FIG. 2 is a flowchart of an embodiment of a method of provisioning software to mobile devices wirelessly without requiring manual entry of application configuration parameters by the user. At step 30, a user of a mobile device registers the mobile device. Registration of a mobile device may entail the user logging in at a predetermined website via user interface 20. The user may be requested to supply a user name and password via user interface 20, for example. Alternatively, the mobile device may automatically transmit a unique device identifier or ID to user interface 20 at registration. Server 12 may look up in data storage device 18 the mobile device type in response to the user identifier and/or device identifier. Furthermore, server 12 may look up the device characteristics, configuration parameters and the one or more software applications to be downloaded to the mobile device in response to the device type. The device characteristics may include the device type, the device operating system, device address (e.g., Short Message Service (SMS) address, Multimedia Message Service (MMS) address, Internet Protocol (IP) address), and other device information. In response to receiving the registration information, server 12 generates a configuration file in step 32. The configuration file may include a number of user-specific parameters, device-specific parameters, and/or application-specific parameters needed to install and execute the software application in the mobile device, such as user identifier, device identifier, device type, device operating system, application name, etc. A generic term, configuration parameter, may be used to refer collectively to these parameters that are bundled together with the software code. The generated configuration file is then bundled or otherwise combined with the software application to be downloaded and installation code in step 34. The resultant file is an installer or setup file. The installer file is then stored at a predetermined location, perhaps in data storage device 18, accessible by computer network 16 via an address or handle, such as a Uniform Resource Locator (URL) in step 36. In step 38, the address or URL for the installer file is then transmitted to the mobile device via a predetermined service such as SMS or MMS, for example.

The user receives the address of the installer file and accesses the installer file by using the provided address in step 40. For example, the user may click on the URL to request the installer file via Hypertext Transfer Protocol (HTTP). The server then sends the installer file to the mobile device in step 42. Once the installer file is downloaded directly into the mobile device, it is executed to install the one or more bundled software applications automatically, and configuration parameters for the software application are automatically extracted from the bundled file and used to populate the parameter values where needed in step 44. The software code is thus downloaded and installed in the mobile device and ready for execution.

The installer file may optionally inform the server that code download and installation have been successfully completed. Alternatively, the software application, upon its initial execution, may provide feedback to server 12 such as notifying server 12 that the download and installation was performed successfully in step 46. Other feedback or acknowledgement methods may also be used. Upon receiving the installation confirmation, server 12 may delete the bundled file from the storage device since it is no longer needed.

Although the system and method described herein may be used to deploy and install software applications, they may be used to download and install other types of data files, such as ringer tones, screen savers, screen background designs, display fonts, user address books, user notes, task lists, and calendars, media files, for example. The user no longer needs to use a desktop computer to first download the application and enter parameters, and then transfer the software via a communication link to the mobile device from the desktop computer. Therefore, the user may register, download and install software applications onto mobile devices by effectively leveraging the wireless data channel.

What is claimed is:

1. A system of provisioning software comprising:
a server operable to communicate wirelessly with a plurality of mobile devices;
a data storage accessible by the server and operable to store device characteristics and device type of the plurality of mobile devices; and
a user interface operable to receive a device registration from each of the plurality of wireless devices; and
the server operable to configure and download an installer file including at least one software application bundled with at least one configuration parameter to the plurality of mobile devices via wireless communication.

2. The system of claim 1, wherein the user interface comprises a web interface.

3. The system of claim 1, wherein the at least one configuration parameter comprises device-specific parameters.

4. The system of claim 1, wherein the at least one configuration parameter comprises application-specific parameters.

5. The system of claim 1, wherein the at least one configuration parameter comprises user-specific parameters.

6. A method comprising:
receiving user registration information wirelessly from a mobile device;
configuring an installer file including at least one software application and at least one configuration parameter bundled together in response to the user registration information;
storing the installer file at a predetermined location;
sending an address of the predetermined location of the installer file wirelessly to the mobile device;
transmitting the installer file to the mobile device wirelessly upon a user request sent from the mobile device; and
installing the at least one software application in the mobile device using the at least one configuration parameter.

7. The method of claim 6, wherein receiving user registration information comprises receiving a user identifier.

8. The method of claim 6, wherein receiving user registration information comprises receiving user login information.

9. The method of claim 6, wherein receiving user registration information comprises receiving a unique device identifier.

10. The method of claim 6, wherein configuring an installer file comprises bundling application-specific configuration parameter with the software application.

11. The method of claim 6, wherein configuring an installer file comprises bundling device-specific configuration parameter with the software application.

12. The method of claim 6, wherein configuring an installer file comprises bundling user-specific configuration parameter with the software application.

13. The method of claim 6, further comprising receiving a user request for the installer file.

14. The method of claim 6, wherein sending an address of the predetermined location of the installer file comprises sending an URL to the mobile device.

15. A computer-readable medium having encoded thereon a method comprising:
receiving user registration information wirelessly from a mobile device;
forming an installer file including at least one software application and at least one configuration parameter bundled together in response to the user registration information;
storing the installer file at a predetermined location;
sending an address of the predetermined location of the installer file wirelessly to the mobile device;
receiving a request for the installer file wirelessly from the mobile device;
transmitting the installer file to the mobile device wirelessly; and
executing the installer file and installing the at least one software application in the mobile device using the at least one configuration parameter.

16. The method of claim 15, wherein receiving user registration information comprises receiving a user identifier.

17. The method of claim 15, wherein receiving user registration information comprises receiving user login information.

18. The method of claim 15, wherein receiving user registration information comprises receiving a unique device identifier.

19. The method of claim 15, wherein configuring an installer file comprises bundling application-specific configuration parameter with the software application.

20. The method of claim 15, wherein configuring an installer file comprises bundling device-specific configuration parameter with the software application.

21. The method of claim 15, wherein configuring an installer file comprises bundling user-specific configuration parameter with the software application.

22. The method of claim 15, further comprising receiving a user request for the installer file.

23. The method of claim 15, wherein sending an address of the predetermined location of the installer file comprises sending an URL to the mobile device.
